(19) United States
(12) Patent Application Publication
(10) Pub. No.: US 2022/0161994 A1
(43) Pub. Date: May 26, 2022

(54) Outdoor Garbage Container

(71) Applicant: Isaac Blake, III, Staten Island, NY (US)

(72) Inventor: Isaac Blake, III, Staten Island, NY (US)

(21) Appl. No.: 17/508,618

(22) Filed: Oct. 22, 2021

Related U.S. Application Data
(60) Provisional application No. 63/118,392, filed on Nov. 25, 2020.

(51) Int. Cl. B65F 1/02; B65F 1/14; B65F 1/16

(52) U.S. Cl. CPC B65F 1/02; B65F 2210/132; B65F 1/1646; B65F 1/1473

(57) ABSTRACT

An outdoor garbage container is an apparatus that retains garbage outdoors for collection without fluids collecting within or under the apparatus under any weather condition. The apparatus may include a wheeled receptacle, a storable lid, a base riser, and a handle assembly. The wheeled receptacle is a hollow structure large enough to retain a desired amount of garbage. The storable lid enables the selective closure of the wheeled receptacle and can be easily stored away to prevent the storable lid from being blown off during harsh weather conditions. The base riser keeps the wheeled receptacle elevated above ground to prevent liquids from accumulating under the wheeled receptacle by enabling the flow of liquids under the wheeled receptacle. The handle assembly facilitates the maneuvering of the wheeled receptacle during transportation to the curbside when the wheeled receptacle is retaining garbage.

The current application claims a priority to the U.S. provisional patent application Ser. No. 63/118,392 filed on Nov. 25, 2020.

### FIELD OF THE INVENTION

The present invention relates generally to trash receptacles and outdoor devices. More specifically, the present invention provides a wheeled trash receptacle with a base equipped with draining means and a storable lid.

### BACKGROUND OF THE INVENTION

In modern society, garbage collection from residential areas is a regular aspect of life for most people. People often keep track of when garbage collection is due each week; sometimes even emptying their refrigerator and freezer of food just prior to garbage collection day. However, the garbage collection services cannot sometimes make it to the residential areas due to various weather conditions, like snowstorms or heavy rain. In such weather conditions, garbage collection can only be initiated afterwards, which results in a substantial amount of liquid collecting within the garbage receptacles left at the curbsides of residences. The collected liquid increases the weight of the garbage receptacle unnecessarily, which can cause strain on the bodies of the garbage collectors emptying the garbage receptacle of its content. Also, stagnant water, or liquid of any kind, in a garbage receptacle invites a host of mosquitos, flies, maggots, and other infestations of pests that are attracted to pools of liquids, which can be hazardous to human health. Further, stagnant liquids sealed within a garbage receptacle can create a build-up of noxious fumes, odors, and smells that are unappealing for humans living in a residential area but are attractive to unwanted pests, critters, and other similar infestations. Common garbage receptacles placed on residential curbsides also have the tendency, when filled, to be easily knocked or tipped over during a storm or other weather conditions, which causes the contents to be spilled out to the open for critters, pests, and other similar infestations to tear through the garbage to find something edible. Furthermore, the corresponding lids of common garbage receptacles tend be easily lost during a storm or other similar weather conditions.

Therefore, an objective of the present invention is to provide an outdoor garbage container with integrated drainage means and equipped with a storable lid. The present invention allows water and other liquids collected within the container to be drained out to maintain the inside of the container as dry as possible. Another objective of the present invention is to provide an outdoor garbage container with drainage means that prevents pests from getting into the container without disrupting the drainage capabilities. Another objective of the present invention is to provide an outdoor garbage container with a storable lid that can be slid in and out of a compartment of the container. Another objective of the present invention is to provide an outdoor garbage container that is raised above the ground to allow surrounding liquids to flow under the container to prevent liquids from pooling under or around the container. Another objective of the present invention is to provide an outdoor garbage container with a base that prevents the container from being easily tipped over. Additional features and benefits of the present invention are further discussed in the sections below.

### SUMMARY OF THE INVENTION

The present invention is an outdoor garbage container designed to prevent liquids from accumulating within or under the container. The present invention includes drainage means such as drainage openings integrated in the base of the container that enable liquids to be discharged so that the interior the container remains dry. The drainage means of the present invention also include means to block pest from entering the container through the drainage means, such a wire mesh. Further, the base of the present invention is designed to provide balance to the container while raising the container above ground in order to prevent liquids surrounding the container to pool under or around the container. To do so, the base provides means to allow liquids to flow under the container so that the liquids do not accumulate under the container which may encourage the growth of maggots and other pests. Furthermore, the present invention includes a storable lid that can be stored within a compartment of the container to prevent the storable lid from being flow off or for easy access to the container.

### BRIEF DESCRIPTION OF THE DRAWINGS

FIG. 1 is a top perspective view of the present invention, wherein the storable lid is shown sealing the receptacle opening.

FIG. 2 is a bottom perspective view of the present invention.

FIG. 3 is a front view of the present invention.

FIG. 4 is a vertical cross-sectional view of the present invention taken along line 4-4 in

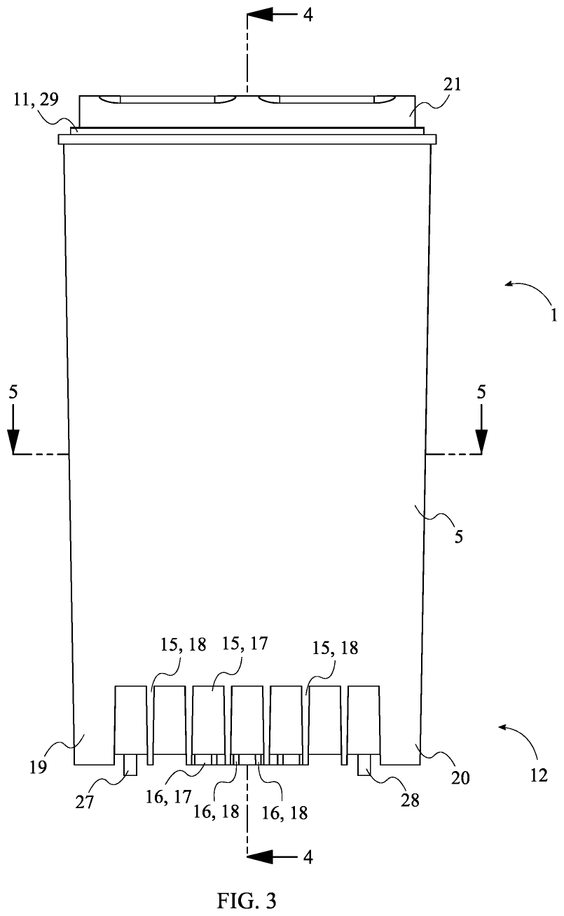

FIG. 3.

FIG. 5 is a horizontal cross-sectional view of the present invention taken along line 4-4 in FIG. 3.

FIG. 6 is a side view of the present invention.

FIG. 7 is a vertical cross-sectional view of the present invention taken along line 7-7 in

FIG. 6.

FIG. 8 is a reduced top perspective view of the present invention, wherein the storable lid is shown open, and wherein the receptacle opening is shown exposed.

FIG. 9 is top perspective view of the present invention, wherein the storable lid is shown positioned within the lid compartment.

FIG. 10 is a front view of the present invention, wherein the storable lid is shown positioned within the lid compartment.

FIG. 11 is a vertical cross-sectional view of the present invention taken along line 11-11 in FIG. 10.

### DETAIL DESCRIPTIONS OF THE INVENTION

All illustrations of the drawings describe selected versions of the present invention and are not intended to limit the scope of the present invention. All references of user or users pertain to either individual or individuals who would utilize the present invention.

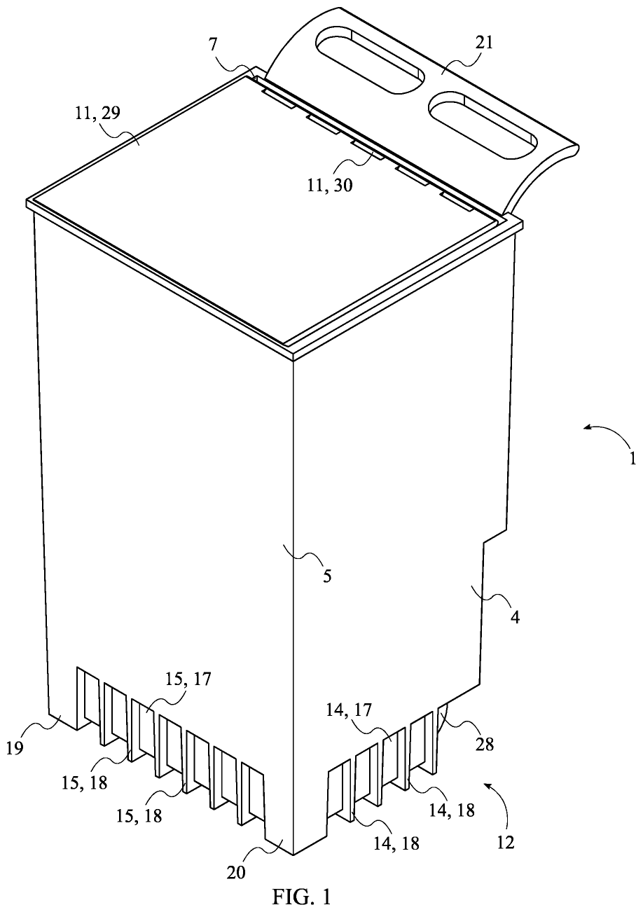

The present invention is an outdoor garbage container that retains garbage outdoors for collection without liquids accumulating within or under the present invention in any weather condition. As shown in FIG. 1 through 3, the present invention may comprise a wheeled receptacle 1, a storable lid 11, a base riser 12, and a handle assembly 21. The wheeled receptacle 1 is a hollow structure that is large enough to retain a desired amount of garbage. The storable lid 11 enables the selective closure of the wheeled receptacle 1 and can be easily stored away to prevent the storable lid 11 from being blown off due to harsh weather conditions. The base riser 12 keeps the wheeled receptacle 1 elevated above ground to prevent liquids from accumulating under or around the wheeled receptacle 1 by enabling liquids to flow under the wheeled receptacle 1. The handle assembly 21 facilitates the maneuvering of the wheeled receptacle 1 when the wheeled receptacle 1 is being moved to/from the curbside.

The general configuration of the aforementioned components enables users to easily take out their garbage for collection without worrying about fluids from the garbage or the weather accumulating within or under the present invention. As shown in FIGS. 1, 2, 8, and 9, the wheeled receptacle 1 has a polygonal shape with a height preferably larger than the width and/or the length of the wheeled receptacle 1. In addition, the wheeled receptacle 1 provides a major opening through which garbage is deposited and emptied out. Accordingly, the wheeled receptacle 1 comprises a receptacle opening 2, a first lateral panel 3, a second lateral panel 4, a front panel 5, a rear panel 6, a lid compartment 7, and a perforated base 8. The first lateral panel 3, the second lateral panel 4, the front panel 5, the rear panel 6, and the perforated base 8 form the hollow structure of the wheeled receptacle 1. The receptacle opening 2 provides access to the interior of the wheeled receptacle 1 for depositing garbage into the wheeled receptacle 1 or to empty the wheeled receptacle 1 out. Further, the lid compartment 7 is a separate compartment from the main storage space that retains the storable lid 11 adjacent to the wheeled receptacle 1 when the storable lid 11 is not being used.

To form the wheeled receptacle 1, the first lateral panel 3 is connected adjacent to the front panel 5, as shown in FIG. 1 through 7. The second lateral panel 4 is also connected adjacent to the front panel 5, opposite the first lateral panel 3. To close the lateral structure of the wheeled receptacle 1, the rear panel 6 is connected adjacent to the first lateral panel 3, opposite the front panel 5. The rear panel 6 is also connected adjacent to the second lateral panel 4, opposite the front panel 5. This arrangement of the panels forms a four-walled structure, but additional panels can be included to form other polygonal shapes. Further, to close the base of the wheeled receptacle 1 which preferably corresponds to the bottom of the wheeled receptacle 1, the first lateral panel 3, the second lateral panel 4, the front panel 5, and the rear panel 6 are perimetrically connected to the perforated base 8. Consequently, the receptacle opening 2 is positioned opposite the perforated base 8 about the wheeled receptacle 1, through which garbage is put in and taken out. This leaves the base of the wheeled receptacle 1 preferably corresponding to the top of the wheeled receptacle 1 open. Moreover, the lid compartment 7 is connected onto the rear panel 6, opposite to the first lateral panel 3 and the second lateral panel 4. This positions the lid compartment 7 outside the wheeled receptacle 1 so that the storable lid 11 does not obstruct with the receptacle opening 2. The base riser 12 is connected onto the perforated base 8, external to the wheeled receptacle 1, to elevate the perforated base 8 at a height above the ground.

Furthermore, the handle assembly 21 is mounted onto the lid compartment 7, opposite to the rear panel 6, to provide the user with means to guide the movement of the wheeled receptacle 1 when the wheeled receptacle 1 is being transported. As shown in FIGS. 1, 8, and 9, the handle assembly 21 is mounted onto the lid compartment 7 without obstructing the operation of the storable lid 11. To close the wheeled receptacle 1, the storable lid 11 is positioned adjacent to the receptacle opening 2 to seal the receptacle opening 2. In addition, to facilitate the storing of the storable lid 11, the storable lid 11 is operatively coupled to the lid compartment 7, wherein the lid compartment 7 is used to receive and situate the storable lid 11. For example, the storable lid 11 may include a lid body 29 and a carriage 30. The lid compartment 7 preferably has a shape and size large enough to accommodate the lid body 29 and the carriage 30. The lid body 29 may be hingedly connected to the carriage 30, while the carriage 30 may be slidably connected within the lid compartment 7. Thus, when the user wants to close the wheeled receptacle 1, the carriage 30 is pulled out of the lid compartment 7 until the lid body 29 is positioned outside the lid compartment 7. The lid body 29 may also include a lip that enables the user to easily grab onto the lid body 29. The lid body 29 can then be positioned against the receptacle opening 2 to seal the wheeled receptacle 1. On the other hand, to store the storable lid 11 away, the lid body 29 is pivoted upwards until positioned parallel to the lid compartment 7. Then, the user pushes the carriage 30 and the lid body 29 into the lid compartment 7 so that the storable lid 11 is safely stored within the lid compartment 7. In other embodiments, the storable lid 11 may utilize different means to be stored within the lid compartment 7.

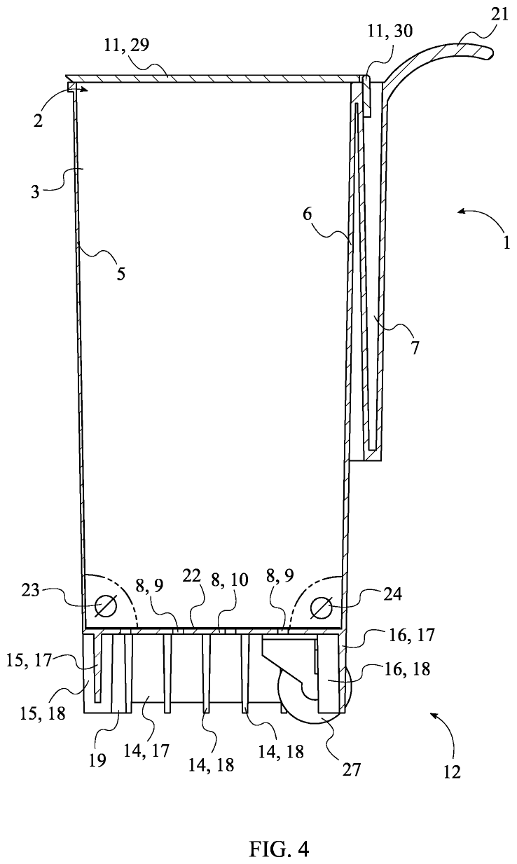

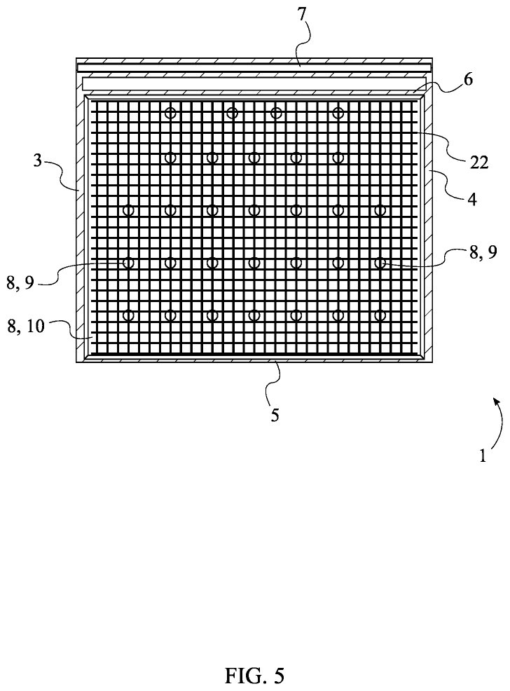

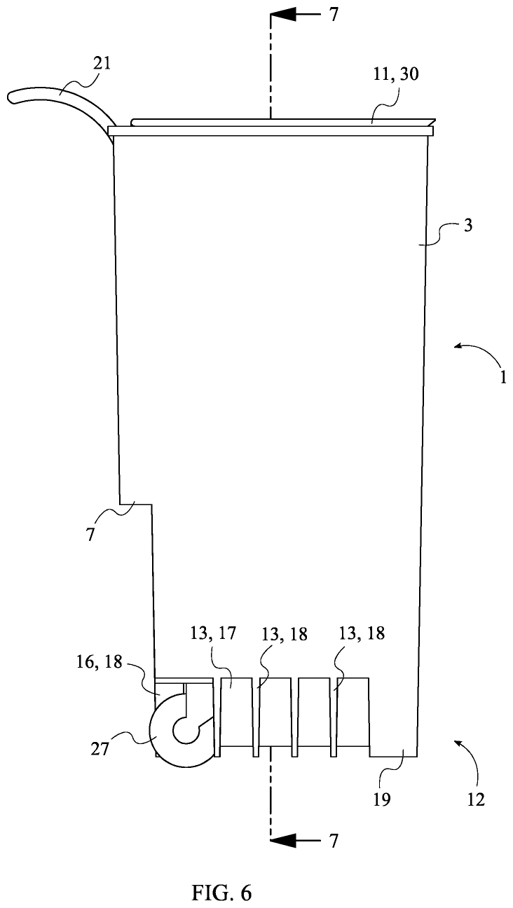

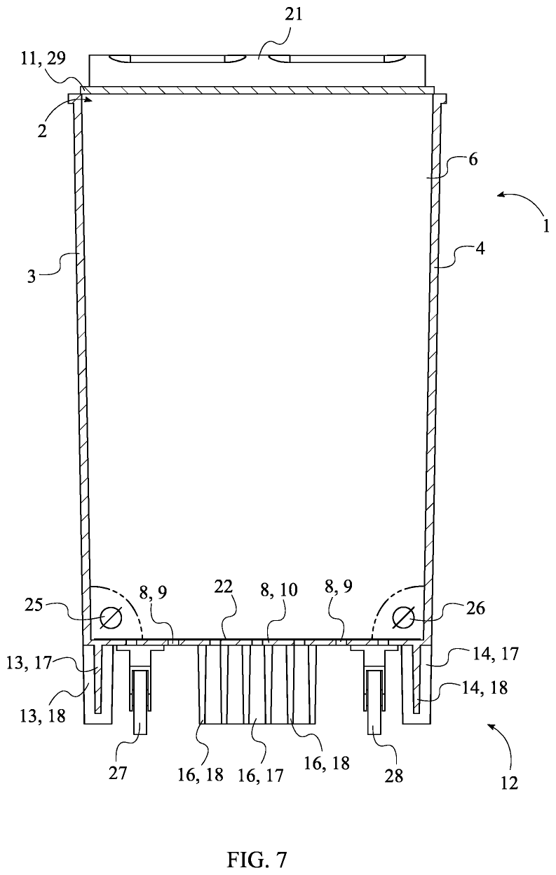

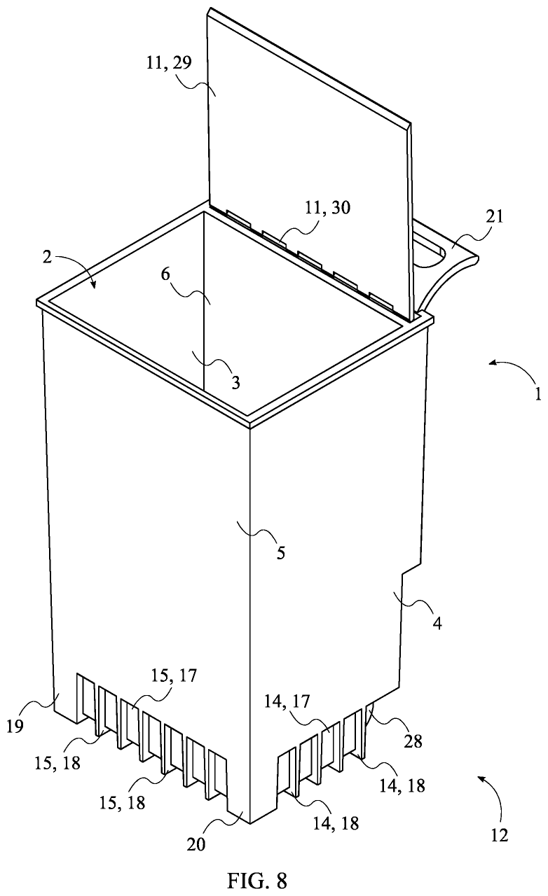

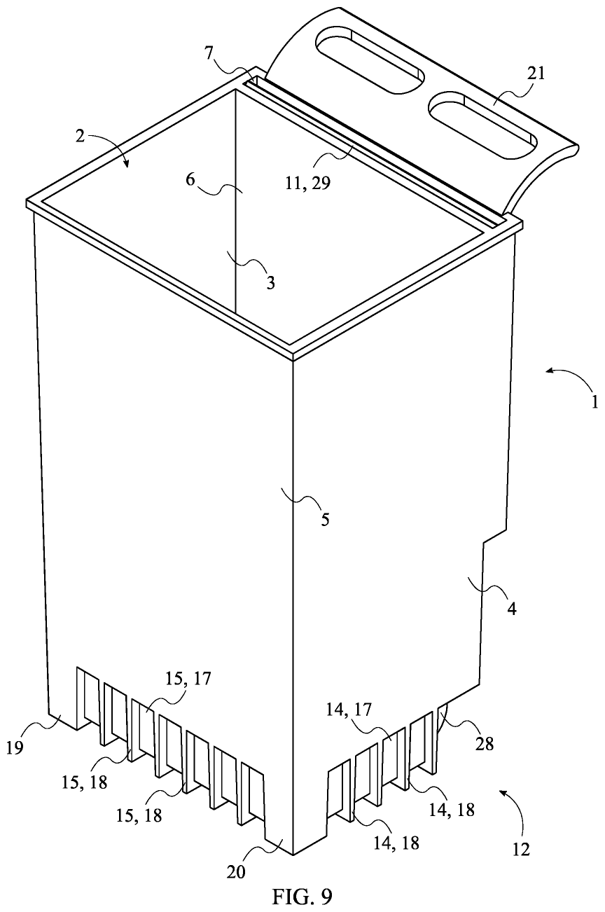

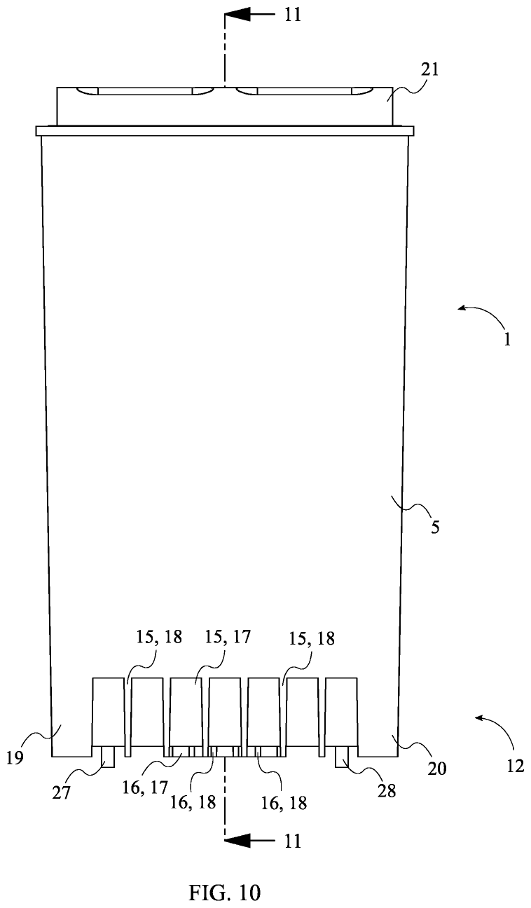

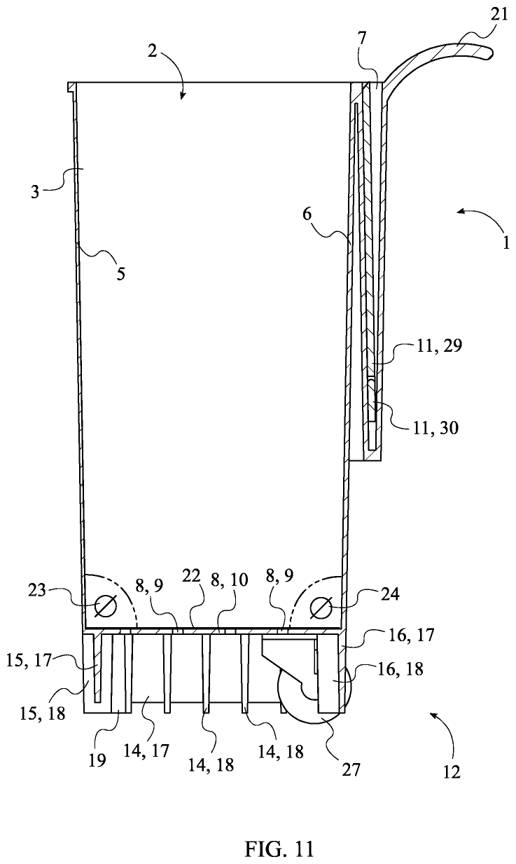

As previously discussed, the present invention includes means to enable any liquid within the wheeled receptacle 1 to be drained out. So, the perforated base 8 may comprise a plurality of drainage openings 9 and a planar base body 10, as shown in FIGS. 4 and 5. The planar base body 10 preferably corresponds to the body of the perforated base 8 that supports the weight of the garbage within the wheeled receptacle 1. The plurality of drainage openings 9 enables any liquid within the wheeled receptacle 1 to flow out of the wheeled receptacle 1. Each of the plurality of drainage openings 9 traverse normal through the planar base body 10 so that liquids flow through the planar base body 10 and out of the wheeled receptacle 1. Further, the plurality of drainage openings 9 is distributed across the planar base body 10 to ensure that no liquid is trapped within the wheeled receptacle 1 by the planar base body 10.

In order to prevent pests from entering the wheeled receptacle 1 through the plurality of drainage openings 9, the present invention may further comprise at least one mesh sheet 22. As shown in FIGS. 4 and 5, the at least one mesh sheet 22 enables fluids to pass through the plurality of drainage openings 9 while blocking pests and other solids from passing through the plurality of drainage openings 9. To do so, the at least one mesh sheet 22 is positioned within the wheeled receptacle 1 to keep the at least one mesh sheet 22 against the perforated base 8. In addition, the at least one mesh sheet 22 is situated across the perforated base 8 to ensure that each of the plurality of drainage openings 9 is covered by the at least one mesh sheet 22. In other embodiments, the present invention may utilize other mechanisms to prevent pests from entering the wheeled receptacle 1 through the plurality of drainage openings 9.

To facilitate the drainage of liquids from the wheeled receptacle 1, the wheeled receptacle 1 is designed to promote the downflow of liquids within the wheeled receptacle 1 and out through the perforated base 8. So, as shown in FIGS. 4, 7, and 11, the front panel 5 may be oriented with the perforated base 8 at a front obtuse angle 23. The rear panel 6 may also be oriented with the perforated base 8 at a rear obtuse angle 24. Similarly, the first lateral panel 3 may be oriented with the perforated base 8 at a first lateral obtuse angle 25. The second lateral panel 4 may also be oriented with the perforated base 8 at a second lateral obtuse angle 26. In some embodiments, the front obtuse angle 23, the rear obtuse angle 24, the first lateral obtuse angle 25, and the second lateral obtuse angle 26 may be equal, thus forming a symmetrical upside-down trapezoidal structure. Alternatively, the front obtuse angle 23, the rear obtuse angle 24, the first lateral obtuse angle 25, and the second lateral obtuse angle 26 may not be equal, thus forming an asymmetrical upside-down trapezoidal structure. In other embodiments, the front obtuse angle 23, the rear obtuse angle 24, the first lateral obtuse angle 25, and the second lateral obtuse angle 26 may be replaced with right angles to form a straight rectangular structure.

In addition to keeping the wheeled receptacle 1 elevated, the base riser 12 also enables the flow of liquids under the wheeled receptacle 1 so that liquids do not pool under the wheeled receptacle 1. Thus, the base riser 12 may comprise a first lateral support 13, a second lateral support 14, and a front support 15. As shown in FIGS. 1, 2, 8, and 9, the first lateral support 13 and the second lateral support 14 provide lateral support to prevent the wheeled receptacle 1 from being knocked over laterally. On the other hand, the front support 15 prevents the wheeled receptacle 1 from tipping forward. So, the front support 15 is connected onto the perforated base 8, adjacent to the front support 15. The first lateral support 13 is connected onto the perforated base 8, adjacent to the first lateral support 13. Similarly, the second lateral support 14 is connected onto the perforated base 8, adjacent to the second lateral support 14. This arrangement of the three supports forms a support skirt under the wheeled receptacle 1 that provides wide support to the wheeled receptacle 1. Further, to provide additional support on the bottom front corners of the wheeled receptacle 1, the base riser 12 may further comprise a first corner support 19 and a second corner support 20. The first corner support 19 and the second corner support 20 are connected onto the perforated base 8 to receive some of the load from the wheeled receptacle 1. The first corner support 19 is intersected by the first lateral support 13 and the front support 15. Likewise, the second corner support 20 is intersected by the front support 15 and the second lateral support 14. Thus, the support skirt is fully closed on the front to provide the most support to the wheeled receptacle 1.

Furthermore, to enable liquids to flow under the perforated base 8, the front support 15, the first lateral support 13, and the second lateral support 14 may each comprise a support panel 17 and a plurality of support ribs 18. As shown in FIGS. 1, 2, 8, and 9, the support panel 17 and the plurality of support ribs 18 are arranged in such a manner that small gaps are formed under the support panel 17 to enable liquids to flow under the support panel 17. To do so, each of the plurality of support ribs 18 is laterally connected to the support panel 17, wherein several gaps are formed under the support panel 17 by the plurality of support ribs 18. These gaps are formed by making the length of each of the plurality of support ribs 18 longer than the width of the support panel 17. Furthermore, the plurality of support ribs 18 is distributed along the support panel 17 to spread the load out under the perforated base 8. In other embodiments, the base riser 12 can be designed differently to enable liquids to flow under the perforated base 8 in specific directions.

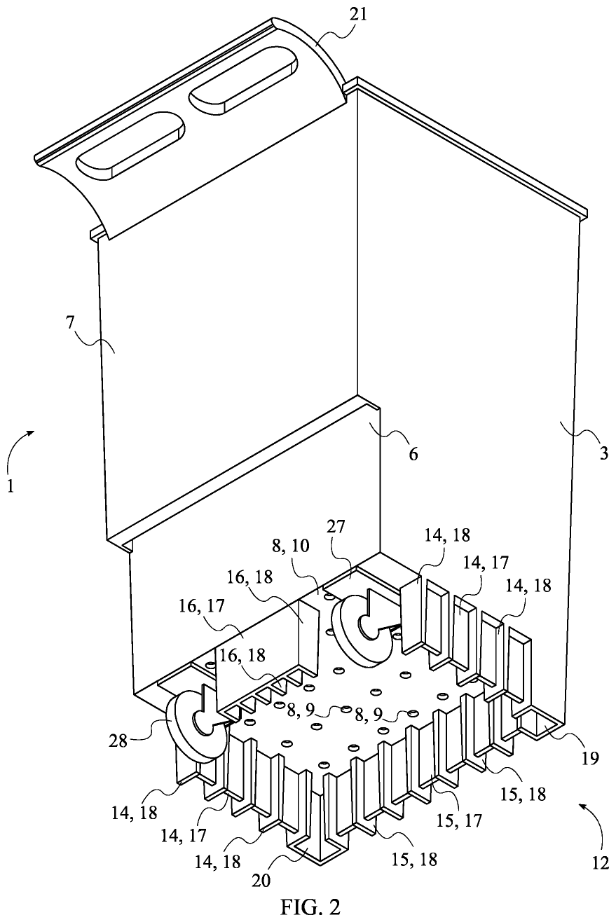

To make the wheeled receptacle 1 transportable, the wheeled receptacle 1 may further comprise at least one first wheel 27 and at least one second wheel 28, as shown in FIGS. 2 and 7. Both the at least one first wheel 27 and the at least one second wheel 28 enable the user to push or drag the wheeled receptacle 1 to/from the curbside. To do so, the at least one first wheel 27 is rotatably mounted to the perforated base 8, adjacent to the rear panel 6. Likewise, the at least one second wheel 28 is rotatably mounted to the perforated base 8, adjacent to the rear panel 6. Further, the at least one first wheel 27 and the at least one second wheel 28 are positioned offset from each other to spread the load from the wheeled receptacle 1. This also enables the user to maneuver the wheeled receptacle 1 using the handle assembly 21 while the wheeled receptacle 1 is tipped and balanced on the at least one first wheel 27 and the at least one second wheel 28. Moreover, the at least one first wheel 27 and the at least one second wheel 28 are positioned offset from the base riser 12 so that the base riser 12 does not obstruct the rotation of the at least one first wheel 27 and the at least one second wheel 28. In other embodiments, the at least one first wheel 27 may be several first wheels and the at least one second wheel 28 may be several second wheels designed to support heavier loads from the wheeled receptacle 1.

As shown in FIGS. 2 and 7, to provide additional support on the rear of the wheeled receptacle 1, the base riser 12 may further comprise a rear support 16 that alleviates the load on the at least one first wheel 27 and the at least one second wheel 28 when the wheeled receptacle 1 is stationary. The rear support 16 also serves to prevent the wheeled receptacle 1 from tipping backwards. To do so, the rear support 16 is connected onto the perforated base 8, adjacent to the rear panel 6. In addition, the rear support 16 is positioned in between the at least one first wheel 27 and the at least one second wheel 28 to not obstruct with the rotation of the at least one first wheel 27 and the at least one second wheel 28. In addition, similar to the support skirt, the rear support 16 is designed to enable the flow of liquids under the perforated base 8. To do so, the rear support 16 may comprise a support panel 17 and a plurality of support ribs 18. The support panel 17 and the plurality of support ribs 18 are arranged in such a manner that small gaps are formed under the support panel 17 to enable liquids to flow under the perforated base 8. To do so, each of the plurality of support ribs 18 is laterally connected to the support panel 17, wherein several gaps are formed under the support panel 17 by the plurality of support ribs 18. These gaps are formed by making the length of each of the plurality of support ribs 18 longer than the width of the support panel 17. Furthermore, the plurality of support ribs 18 is distributed along the support panel 17 to spread the load out under the perforated base 8. In other embodiments, the base riser 12 may be modified to include different support components to accommodate different shapes of wheeled receptacle 1.

Although the invention has been explained in relation to its preferred embodiment, it is to be understood that many other possible modifications and variations can be made without departing from the spirit and scope of the invention.

What is claimed is:

1. An outdoor garbage container comprising:
a wheeled receptacle;
a storable lid;
a base riser;
a handle assembly;
the wheeled receptacle comprising a receptacle opening, a first lateral panel, a second lateral panel, a front panel, a rear panel, a lid compartment, and a perforated base;
the first lateral panel being connected adjacent to the front panel;
the second lateral panel being connected adjacent to the front panel, opposite the first lateral panel;
the rear panel being connected adjacent to the first lateral panel, opposite the front panel;
the rear panel being connected adjacent to the second lateral panel, opposite the front panel;
the first lateral panel, the second lateral panel, the front panel, and the rear panel being perimetrically connected to the perforated base;
the receptacle opening being positioned opposite the perforated base about the wheeled receptacle;
the lid compartment being connected onto the rear panel, opposite to the first lateral panel and the second lateral panel;
the base riser being connected onto the perforated base, external to the wheeled receptacle;
the handle assembly being mounted onto the lid compartment, opposite to the rear panel;
the storable lid being positioned adjacent to the receptacle opening; and,
the storable lid being operatively coupled to the lid compartment, wherein the lid compartment is used to receive and situate the storable lid.

2. The wheeled receptacle with drainage as claimed in claim 1 comprising:
the perforated base comprising a plurality of drainage openings and a planar base body;
each of the plurality of drainage openings traversing normal through the planar base body; and,
the plurality of drainage openings being distributed across the planar base body.

3. The wheeled receptacle with drainage as claimed in claim 1 comprising:
at least one mesh sheet;
the at least one mesh sheet being positioned within the wheeled receptacle; and,
the at least one mesh sheet being situated across the perforated base.

4. The wheeled receptacle with drainage as claimed in claim 1, wherein the front panel is oriented with the perforated base at a front obtuse angle.

5. The wheeled receptacle with drainage as claimed in claim 1, wherein the rear panel is oriented with the perforated base at a rear obtuse angle.

6. The wheeled receptacle with drainage as claimed in claim 1, wherein the first lateral panel is oriented with the perforated base at a first lateral obtuse angle.

7. The wheeled receptacle with drainage as claimed in claim 1, wherein the second lateral panel is oriented with the perforated base at a second lateral obtuse angle.

8. The wheeled receptacle with drainage as claimed in claim 1 comprising:
the base riser comprising a first lateral support, a second lateral support, and a front support;
the front support being connected onto the perforated base, adjacent to the front support;
the first lateral support being connected onto the perforated base, adjacent to the first lateral support; and,
the second lateral support being connected onto the perforated base, adjacent to the second lateral support.

9. The wheeled receptacle with drainage as claimed in claim 8 comprising:
the base riser further comprising a first corner support and a second corner support;
the first corner support and the second corner support being connected onto the perforated base;
the first corner support being intersected by the first lateral support and the front support; and,
the second corner support being intersected by the front support and the second lateral support.

10. The wheeled receptacle with drainage as claimed in claim 8 comprising:
the front support, the first lateral support, and the second lateral support each comprising a support panel and a plurality of support ribs;
each of the plurality of support ribs being laterally connected to the support panel; and,
the plurality of support ribs being distributed along the support panel.

11. The wheeled receptacle with drainage as claimed in claim 1 comprising:
the wheeled receptacle further comprising at least one first wheel and at least one second wheel;
the at least one first wheel being rotatably mounted to the perforated base, adjacent to the rear panel;
the at least one second wheel being rotatably mounted to the perforated base, adjacent to the rear panel;
the at least one first wheel and the at least one second wheel being positioned offset from each other; and,
the at least one first wheel and the at least one second wheel being positioned offset from the base riser.

12. The wheeled receptacle with drainage as claimed in claim 11 comprising:
the base riser further comprising a rear support;
the rear support being connected onto the perforated base, adjacent to the rear panel; and,
the rear support being positioned in between the at least one first wheel and the at least one second wheel.

13. The wheeled receptacle with drainage as claimed in claim 12 comprising:
the rear support comprising a support panel and a plurality of support ribs;
each of the plurality of support ribs being laterally connected to the support panel; and,
the plurality of support ribs being distributed along the support panel.

14. An outdoor garbage container comprising:
a wheeled receptacle;
a storable lid;
a base riser;
a handle assembly;
at least one mesh sheet;
the wheeled receptacle comprising a receptacle opening, a first lateral panel, a second lateral panel, a front panel, a rear panel, a lid compartment, and a perforated base;
the perforated base comprising a plurality of drainage openings and a planar base body;
the first lateral panel being connected adjacent to the front panel;
the second lateral panel being connected adjacent to the front panel, opposite the first lateral panel;
the rear panel being connected adjacent to the first lateral panel, opposite the front panel;
the rear panel being connected adjacent to the second lateral panel, opposite the front panel;
the first lateral panel, the second lateral panel, the front panel, and the rear panel being perimetrically connected to the perforated base;
the receptacle opening being positioned opposite the perforated base about the wheeled receptacle;
the lid compartment being connected onto the rear panel, opposite to the first lateral panel and the second lateral panel;
the base riser being connected onto the perforated base, external to the wheeled receptacle;
the handle assembly being mounted onto the lid compartment, opposite to the rear panel;
the storable lid being positioned adjacent to the receptacle opening;
the storable lid being operatively coupled to the lid compartment, wherein the lid compartment is used to receive and situate the storable lid;
each of the plurality of drainage openings traversing normal through the planar base body;
the plurality of drainage openings being distributed across the planar base body;
the at least one mesh sheet being positioned within the wheeled receptacle; and,
the at least one mesh sheet being situated across the perforated base.

15. The wheeled receptacle with drainage as claimed in claim 14 comprising:
the front panel being oriented with the perforated base at a front obtuse angle; and,
the rear panel being oriented with the perforated base at a rear obtuse angle.

16. The wheeled receptacle with drainage as claimed in claim 14 comprising:
the first lateral panel being oriented with the perforated base at a first lateral obtuse angle; and,
the second lateral panel being oriented with the perforated base at a second lateral obtuse angle.

17. The wheeled receptacle with drainage as claimed in claim 14 comprising:
the base riser comprising a first lateral support, a second lateral support, a front support, a first corner support, and a second corner support;
the front support being connected onto the perforated base, adjacent to the front support;
the first lateral support being connected onto the perforated base, adjacent to the first lateral support;
the second lateral support being connected onto the perforated base, adjacent to the second lateral support;
the first corner support and the second corner support being connected onto the perforated base;
the first corner support being intersected by the first lateral support and the front support; and,
the second corner support being intersected by the front support and the second lateral support.

18. The wheeled receptacle with drainage as claimed in claim 17 comprising:
the front support, the first lateral support, and the second lateral support each comprising a support panel and a plurality of support ribs;
each of the plurality of support ribs being laterally connected to the support panel; and,
the plurality of support ribs being distributed along the support panel.

19. The wheeled receptacle with drainage as claimed in claim 14 comprising:
the base riser comprising a rear support;
the wheeled receptacle further comprising at least one first wheel and at least one second wheel;
the at least one first wheel being rotatably mounted to the perforated base, adjacent to the rear panel;
the at least one second wheel being rotatably mounted to the perforated base, adjacent to the rear panel;
the at least one first wheel and the at least one second wheel being positioned offset from each other;
the at least one first wheel and the at least one second wheel being positioned offset from the base riser;
the rear support being connected onto the perforated base, adjacent to the rear panel; and,
the rear support being positioned in between the at least one first wheel and the at least one second wheel.

20. The wheeled receptacle with drainage as claimed in claim 19 comprising:
the rear support comprising a support panel and a plurality of support ribs;
each of the plurality of support ribs being laterally connected to the support panel; and,
the plurality of support ribs being distributed along the support panel.
